(19) United States
(12) Patent Application Publication
(10) Pub. No.: US 2025/0204598 A1
(43) Pub. Date: Jun. 26, 2025

(54) Magnetic Electronic Cigarette and its Combined Electronic Cigarette

(71) Applicant: Matrax Tech Corp, Plano, TX (US)

(72) Inventor: Yicheng Ye, Shenzhen (CN)

(21) Appl. No.: 18/419,390

(22) Filed: Jan. 22, 2024

(30) Foreign Application Priority Data
Dec. 22, 2023 (CN) 202323509339.8

(51) Int. Cl. A24F 40/485; A24F 40/95; H01F 7/02

(52) U.S. Cl. CPC A24F 40/485; A24F 40/95; H01F 7/0252

(57) ABSTRACT

A magnetic electronic cigarette and its combined electronic cigarette, which comprise an electronic cigarette unit, wherein the electronic cigarette unit further comprises a shell with an atomizing main part arranged inside. The shell is provided with a magnetic component that be magnetically attached to external objects. Users can combine at least two different flavors of electronic cigarettes through magnetic components, or only smoke a single flavor of electronic cigarette based on needs. At the same time, a wireless charging is performed through wireless coils, eliminating the trouble of entangled charging cables.

### TECHNICAL FIELD

The present utility patent relates to the technical field of electronic cigarette, and in particular, for a magnetic electronic cigarette and its combined electronic cigarette.

### BACKGROUND

Most electronic cigarettes in the existing market are single-flavor products, and multi-flavor products require multiple e-liquid tanks to be designed on the electronic cigarette product. The flavor of each combined electronic cigarette is fixed during production, and cannot be customized according to the user's own needs. When users want to mix and match according to their preference, they can choose to buy two single-flavored electronic cigarettes and align them together. However, this joining method cannot be fixed. During the smoking process, the two electronic cigarettes are easy to shift out of position or fall out of the user's hands, which will affect the user's smoking experience. Therefore, it needs to be improved.

### SUMMARY OF THE PRESENT UTILITY PATENT

Aiming at the defects and deficiencies of the prior art, A magnetic electronic cigarette and its combined electronic cigarette is provided in the present utility patent, which has the advantages of combining two different flavors of electronic cigarettes through magnetic components, and users can also smoke a single flavor of electronic cigarette separately according to their needs. At the same time, wireless charging is achieved through a wireless coil, which eliminates the trouble of entangled charging wires; and no need to unplug and plug in for the charging cable, which is easy to use.

To realize the above purposes, the technical solutions adopted by the present utility patent are: a magnetic electronic cigarette, comprises an electronic cigarette unit, wherein the electronic cigarette unit includes a shell and an atomizing main part arranged in the shell; wherein the shell is provided with a magnetic component that can be magnetically attached to external objects.

The magnetic component comprises: a first magnetic piece and a second magnetic piece, wherein the first magnetic piece is embedded on the front surface of the shell, and the second magnetic piece is embedded on the rear surface of the shell.

The first magnetic piece and the second magnetic piece are both magnets. The first magnetic piece and the second magnetic piece are opposite. The polarity of the sides is opposite.

The first magnetic piece is a magnet, and the second magnetic piece is a metal piece that can be adsorbed and combined with the magnet.

The front surface and the rear surface of the shell are both flat.

The first magnetic piece and the second magnetic piece are both in the shape of an annular ring or a disc.

A wireless charging coil electrically connected to the atomizing main part is provided on the side of the shell close to the second magnetic piece.

A cigarette holder is provided on the top of the shell, and an air inlet hole is provided on the bottom of the shell. And the atomizing main part includes: an atomizing component, a rechargeable battery, and a control circuit board. The fore-mentioned atomizing component, the rechargeable battery and the control circuit board are all arranged in the shell. The atomizing component is connected to the cigarette holder; And the wireless charging coil, the atomizing component and the rechargeable battery are electrically connected to the control circuit board respectively.

A combined electronic cigarette comprises an electronic cigarette unit, wherein the electronic cigarette unit comprises a shell and a atomizing main part arranged in the shell; the shell is provided a magnetic component that can be magnetically attached to external objects; there are at least two electronic cigarette units, and at least two electronic cigarette units are combined together under the adsorption of the magnetic component.

Adopting the above technical solutions, the beneficial effect of the present utility patent is: a magnetic electronic cigarette comprises an electronic cigarette unit. The electronic cigarette unit comprises a shell and an atomizing main part arranged in the shell. The shell is provided with a magnetic component that can be magnetically attached to external objects. Users can purchase two electronic cigarette units with different flavors, and then use the magnetic components on the two electronic cigarette units to adsorb and combine them to achieve fixation between the two electronic cigarette units, which facilitates users to smoke electronic cigarettes with different flavors; at the same time, users can also smoke one flavor of electronic cigarette separately.

A wireless charging coil electrically connected to the atomizing main part is provided on the side of the shell close to the second magnetic piece. Electromagnetic induction charging is performed through the wireless charging coil and an external wireless charger, which eliminates the trouble of entangled charging cables. There is no need to plug in and unplug the charging cable, users can just place and charge, and just take and use, which is smart, convenient, safe, and reliable. There is no preset charging interface, which reduces the possibility of dust and liquid infiltration, effectively avoiding safety risks caused by exposed contact electrodes. In some embodiments, the wireless charging coil is embedded on the second magnetic piece. The wireless charging coil is arranged on the second magnetic piece to facilitate alignment charging between the electronic cigarette unit and the wireless charger.

### BRIEF DESCRIPTION OF THE FIGURES

To better illustrate the technical solutions of the embodiment of the present utility patent (or the technical solutions of the prior art), a brief introduction of the figures that need to be used in the embodiment or the description of the prior art will be given below. As it shown below, the figures in the following description are only some embodiments of the present utility patent, for those of ordinary skilled in the art, other figures can also be obtained based on these figures without inventive efforts.

FIG. 1 is a structure schematic view of the present utility patent;

FIG. 2 is a schematic view of the open state of the shell of the present utility patent;

FIG. 3 is a exploded view of the present utility patent;

FIG. 4 is another exploded view of the present utility patent.

Reference signs in the figures: 1—shell; 2—magnetic component; 21—first magnetic piece; 22—second magnetic piece; 3—atomizing main part; 4—wireless charging coil; a—air inlet hole; 11—cigarette holder; 31—rechargeable battery; 32—control circuit board; b—annular slot.

### DETAILED DESCRIPTION OF THE EMBODIMENTS

Below is a further detailed description of the present utility patent based on the figures.

The present embodiment only shows an explanation of the present utility patent and it is not a limitation to the present utility patent. The skilled in the art can make modifications to this embodiment as needed without making any creative contributions after reading this specification, which are always protected by the patent law as long as they are within the scope of the claims of the present utility patent.

It should be noted that when an element is called as being “fixed to”, “attached to” or “arranged on” another element, it can be directly on the other element or indirectly on the other element. When an element is called as being “connected to” another element, it can be directly connected to the other element or indirectly connected to the other element.

It should be noticed that the terms “length”, “width”, “top”, “bottom”, “front”, “rear”, “left”, “right”, “vertical”, “horizontal”, “top”, “bottom”, “inside” and “outside” which indicates the orientations or positional relationships are based on the orientations or positional relationships shown in the figures. They are only for facilitating describing the present invention and simplifying the description, rather than indicating or implying that the device or component must have a specific orientation, construct and operate in a specific orientation, therefore, it understood as a limitation of the present invention.

In addition, the terms “first” and “second” are used for descriptive purposes only and cannot be understood as indicating or implying relative importance or implicitly indicating the quantity of indicated technical features. Therefore, a feature defined as “first” and “second” may explicitly or implicitly include one or more of these features. In the description of the present invention, “a plurality of” means two or more, unless otherwise specifically defined.

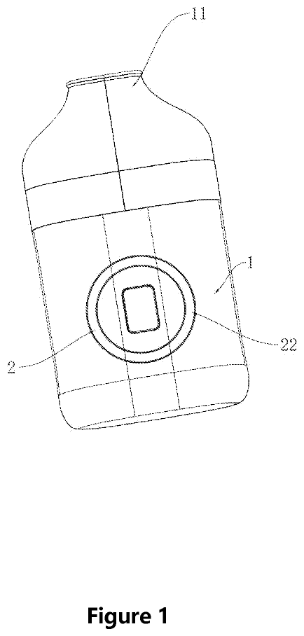

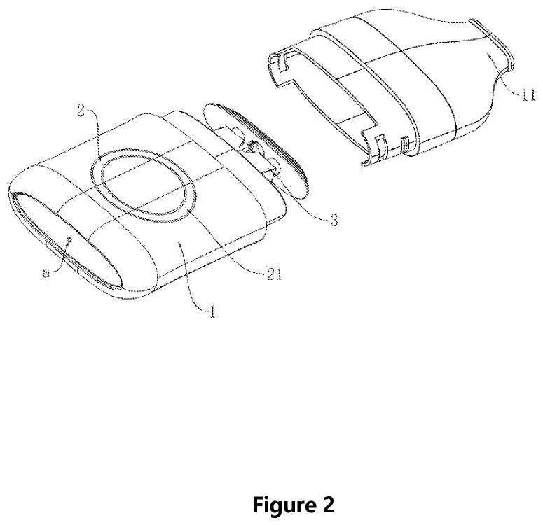

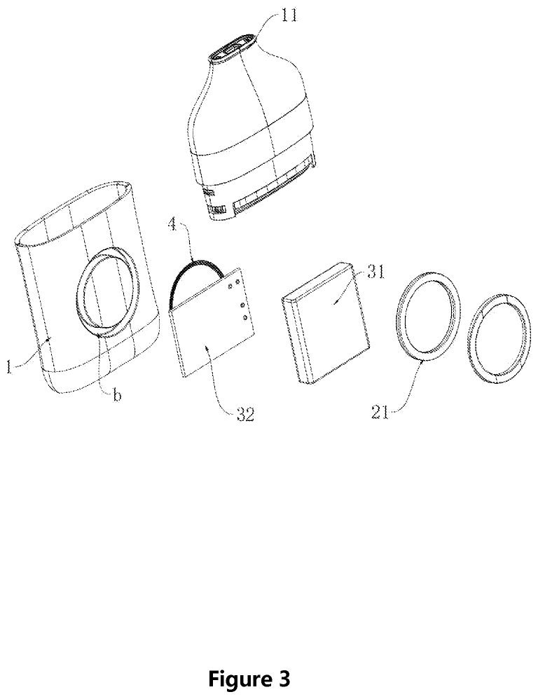

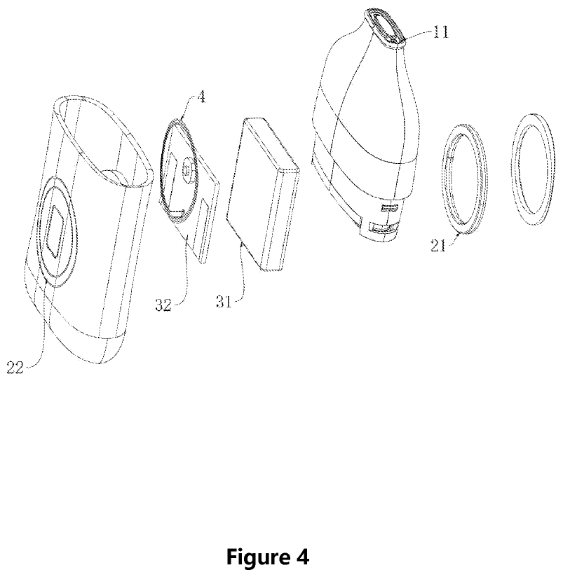

This embodiment relates to a magnetic electronic cigarette, as FIGS. 1-4 shown, comprising an electronic cigarette unit. The electronic cigarette unit comprises a shell 1 and an atomizing main part 3 arranged in the shell 1. The shell 1 is provided with a magnetic component 2 that can be magnetically attached to external objects. In a specific embodiment, as FIGS. 3-4 shown, a cigarette holder 11 is provided on the top of the shell 1, and an air inlet a is provided on the bottom of the shell 1. The atomizing main part 3 comprises: an atomizing component, a rechargeable battery 31 and a control circuit board 32. The atomizing component, the rechargeable battery 31 and the control circuit board 32 are all arranged in the shell 1. The atomizing core of the atomizing component is provided with an atomizing channel connected to the cigarette holder 11. The atomizing component and the rechargeable battery 31 are electrically connected to the control circuit board 32 respectively, and the control circuit board 32 is electrically connected to the atomizing core of the atomizing component. Optionally, the shell 1 is provided with a power switch electrically connected to the control circuit board 32.

It should be noted that users can purchase two electronic cigarette units with different flavors, and then use the magnetic components 2 on the two electronic cigarette units to adsorb and combine them to achieve fixation between the two electronic cigarette units, which facilitates users to smoke electronic cigarettes with different flavors at the same time and users can also smoke one flavor of electronic cigarette separately.

Optionally, in order to facilitate the adsorption and fixation between electronic cigarette units, as FIGS. 1-4 shown, the magnetic component 2 comprises: a first magnetic piece 21 and a second magnetic piece 22. The first magnetic piece 21 is embedded in the outer shell. 1 on the front surface. The second magnetic piece 22 is embedded on the rear surface of the shell 1. In other embodiments, the magnetic component 2 is a magnet embedded on the front surface or the rear surface of the shell 1. In one embodiment, the first magnetic piece 21 is a magnet, and the second magnetic piece 22 are both magnets, and the polarities of opposite sides of the first magnetic piece 21 and the second magnetic piece 22 are opposite. In one embodiment, the first magnetic piece 21 is a magnet, and the second magnetic piece 22 is a metal piece that can be adsorbed and combined with the magnet. In one embodiment, in order to make the adsorption between electronic cigarette units more stable, the front surface and the rear surface of the shell 1 are both flat.

Optionally, as FIG. 3 shown, the front surface of the shell 1 is provided with an annular slot b that is recessed inward, and the first magnetic piece 21 is embedded in the annular slot b.

It should be noted that when at least two electronic cigarettes of different flavors need to be combined and matched, the front surface of one electronic cigarette unit can be brought closer to the rear surface of another electronic cigarette unit, so that the first magnetic piece 21 and the second magnetic piece 22 of the two electronic cigarette units are aligned and adsorbed, which facilitates the user to smoke electronic cigarettes of different flavors at the same time. If users wants to smoke one flavor of electronic cigarette separately, they can directly separate the two electronic cigarette units, causing the magnetic components 2 on the two electronic cigarette units to separate. At the same time, the electronic cigarette body can also be adsorbed on metal objects that can be magnetically attracted, such as the back of a mobile phone, for easy portability. Optionally, the first magnetic piece 21 is in the shape of a ring or a disk but is not limited to a ring or a disk, and the second magnetic piece 22 is in a ring or a disk shape but is not limited to a ring or a disk. shape.

Optionally, as FIGS. 3 and 4 shown, a wireless charging coil 4 electrically connected to the atomizing main part 3 is arranged on the side of the shell 1 close to the second magnetic piece 22. The wireless charging coil 4 is electrically connected to the control circuit board 32.

Electromagnetic induction charging is performed through the wireless charging coil 4 and an external wireless charger, which eliminates the trouble of entangled charging cables. There is no need to plug in and unplug the charging cable. It can just place and charge, and just take and use, which is smart, convenient, safe and reliable. There is no preset charging interface, which reduces the possibility of dust and liquid infiltration, effectively avoiding safety risks caused by exposed contact electrodes. In some embodiments, the wireless charging coil 4 is embedded on the second magnetic piece 22. The wireless charging coil 4 is arranged on the second magnetic piece 22 to facilitate alignment charging between the electronic cigarette unit and the wireless charger.

A combined electronic cigarette comprises the above-mentioned electronic cigarette unit. There are at least two electronic cigarette units, and at least two electronic cigarette units are combined together under the adsorption of the magnetic component 2. In this embodiment, the combined electronic cigarette comprises two electronic cigarettes with different flavors, namely a first electronic cigarette and a second electronic cigarette. When used in combination, the first magnetic piece 21 on the first electronic cigarette and the second magnetic piece 22 of the second electronic cigarette are aligned and adsorbed, thereby realizing the adsorption and combination between the two electronic cigarette units, making it convenient for the user to smoke electronic cigarettes of different flavors at the same time, and at the same time, it is convenient for the user to separate the two electronic cigarette units, which facilitates users to smoke one flavor of electronic cigarette separately.

The above only aims to illustrate the technical solution of the present utility patent without limitation. Any other modifications or equivalent replacements of the technical solution of the present utility patent made by ordinary skilled in the art should be included in the scope of the claims of the present utility patent as long as they do not deviate from the technical solution spirit and scope of the present utility patent.

1. A magnetic electronic cigarette that comprises an electronic cigarette unit, within electronic cigarette unit includes a shell and an atomizing main part arranged in the shell, and the shell is provided with a magnetic component that can be magnetically attached to external objects.

2. The magnetic electronic cigarette according to claim 1, wherein the magnetic component comprises:
a first magnetic piece, which is embedded on front surface of the shell; and
a second magnetic piece, which is embedded on rear surface of the shell.

3. The magnetic electronic cigarette according to claim 2, wherein the first magnetic piece is with its south pole set on outside, and the second magnetic piece is with its north pole set on outside.

4. The magnetic electronic cigarette according to claim 2, wherein the first magnetic piece is a magnet, and the second magnetic piece is a metal piece that be attracted to magnets.

5. The magnetic electronic cigarette according to claim 2, wherein the front surface and the rear surface of the shell are flat.

6. The magnetic electronic cigarette according to claim 2, wherein the first magnetic piece and the second magnetic piece are in shape of an annular ring or a disc.

7. The magnetic electronic cigarette according to claim 2, wherein a wireless charging coil electrically connected to the atomizing main part is provided on a side of the shell close to the second magnetic piece.

8. The magnetic electronic cigarette according to claim 7, wherein a cigarette holder is provided on top side of the shell, and an air inlet hole is provided on bottom side of the shell; and the atomizing main part comprises:
an atomizing component, which is connected to the cigarette holder and arranged inside the shell;
a rechargeable battery, which is arranged inside the shell; and
a control circuit board, which arranged inside the shell and is electrically connected to the wireless charging coil, the rechargeable battery and the atomizing component.

9. A combined electronic cigarette comprises at least two electronic cigarette units, wherein an electronic cigarette unit further comprises a shell and an atomizing main part arranged inside the shell, and the shell is provided with a magnetic component that can be magnetically attached to external objects; and as a result, electronic cigarette units are attracted with each under the adsorption of the magnetic components.
